(19) United States
(12) Patent Application Publication
(10) Pub. No.: US 2005/0263565 A1
(43) Pub. Date: Dec. 1, 2005

(54) Method and device for moving an element by means of a drive

(75) Inventor: Richard Andrianus Johannes Van Der Burg, Eindhoven (NL)

Correspondence Address: FOLEY AND LARDNER;SUITE 500, 3000 K STREET NW, WASHINGTON, DC, 20007, US

(73) Assignee: Assembleon N.V.

(21) Appl. No.: 10/968,343

(22) Filed: Oct. 20, 2004

(30) Foreign Application Priority Data
Oct. 23, 2003 (EP) 03103923.3

(51) Int. Cl. B23K 1/00; B23K 5/00

(52) U.S. Cl. 228/8; 228/6.2; 228/12

(57) ABSTRACT

A method for moving an element using a drive system includes determining a difference between a predetermined value of the position of the element and an actually measured value of the position of the element at frequent intervals using a processor during the movement of the element. A collision of the element with an object is confirmed if the difference is greater than a predetermined parameter. Once the occurrence of a collision has been established, the element may be pressed against the object in a controlled manner using the drive system for a predetermined period of time.

### CROSS-REFERENCE TO RELATED PATENT APPLICATIONS

This application claims priority to European Patent Application No. 03103923.3 filed on Oct. 23, 2003, the entire contents of which are hereby incorporated by reference.

### BACKGROUND

The invention relates to a method for moving an element by means of a drive system. The invention also relates to a device suitable for carrying out such a method. One known method (and the device for performing it) of this nature is described European Patent No. EP-B1-0365681, which teaches a parameter that depends on the driving force of a servo motor and that is detected at frequent intervals; the device assumes that a collision has occurred if the parameter exceeds a predetermined value. As soon as the occurrence of a collision has been established, measures are taken, such as stopping the servo motor to prevent damage from being caused to the machine by the collision or to limit the extent of any such damage.

### SUMMARY

An object of the invention is to provide a method wherein different measures are taken after the occurrence of a collision has been established. This object is achieved with a method by which, once the occurrence of a collision has been established between an element and an object, the element is pressed against the object in a controlled manner by means of a drive system for a predetermined period of time.

An embodiment of this method includes, among other possible steps: (a) determining a difference between a predetermined value of the position of an element and an actually measured value at frequent intervals by means of a processor during the movement of the element; (b) establishing that a collision of the element with an object has taken place if the difference is greater than a predetermined parameter; and (c) pressing the element against the object, by means of the drive system, in a controlled manner and for a predetermined period of time, when the occurrence of a collision has been established.

In another embodiment of the method, a force with which the element is pressed against the object may be maintained at a predetermined value by means of the processor.

In another embodiment of the method, the element may be initially moved relative to the object at a relatively high velocity. Subsequently, as the element nears the object, the speed at which the element is moved relative to the object may be reduced.

In another embodiment of the method, the element may include a component pick-up unit that is provided with a nozzle that generates a vacuum for picking-up a component. In addition, the object may include, or be, the component to be picked-up. Further, the vacuum may be turned on to enable the nozzle to pick-up the component as soon as or after the occurrence of a collision between the nozzle and the component to be picked-up has been established.

In another embodiment of the method, the object may include a substrate on which a component to be picked-up is to be subsequently positioned. The element may include the component pick-up unit, the nozzle, as well as the component, which has been picked-up by means of the nozzle's vacuum. The vacuum may be released as soon as or just after the occurrence of a collision between the component and the substrate has been established.

In another embodiment of the method, the component pick-up unit and the nozzle may be moved away from the substrate after the end of the predetermined period of time during which the component is pressed against the substrate.

In another embodiment of the method, the predetermined value of the force with which the element is pressed against the object may be adjustable.

In another embodiment of the method, a force with which the element is pressed against the object is maintained at a predetermined value by means of the processor. In this way, it is possible to press the element against the object with, for example, a constant force. As a result, it is possible to effect a strong and detachable, if desired, connection between the element and the object.

In another embodiment of the method, the element initially moves relative to the object at a relatively high velocity and is subsequently moved at a relatively low velocity as the element nears the object. As a result of the relatively low velocity of the element upon approaching the object, the forces that occur upon collision between the element and the object will be relatively small. Subsequently, it is possible to press the element against the object with the relatively low force that occurs upon the collision. Thus, no large variations in the forces being exerted on the element or on the object will occur.

In another embodiment of the method, the element comprises a component pick-up unit that is provided with a nozzle that generates a vacuum for picking-up a component. When component pick-up units are used, it is preferable that components can be picked-up in an accurate manner, after which the components should be accurately positioned at a desired position, for example on a substrate. When a component is picked-up, it is preferable that a temporary connection be created between the component pick-up unit and the component, without damaging the component pick-up unit or the component.

Another embodiment of the invention addresses a method of moving a component. This method includes, among other possible steps: (a) aligning a component pick-up unit with the component; (b) decreasing the distance between the component pick-up unit and the component; (c) determining when a collision has occurred between the component pick-up unit and the component; (d) attaching the component to the component pick-up unit; (e) moving the component and the component pick-up unit so as to align the component with a particular region of a substrate; (f) decreasing the distance between the component and the particular region of the substrate; (g) determining when a collision has occurred between the component and the particular region of the substrate; and (h) releasing the component onto the particular region of the substrate.

In another embodiment of this method, the component pick-up unit may include a nozzle that is configured to create a vacuum. Further, the step of attaching the component to the component pick-up unit may include establishing a vacuum between the component and an end of the nozzle.

In another embodiment of this method, the step of depositing component on the particular region of the substrate may include releasing the vacuum between the component and an end of the nozzle.

In another embodiment of this method, the step of determining when the collision has occurred between the component pick-up unit and the component may include comparing an expected location of the nozzle to an actual location of the nozzle.

In another embodiment of this method, the step of determining when the collision has occurred between the component pick-up unit and the component may include comparing an expected location of the component pick-up unit to an actual location of the component pick-up unit.

In another embodiment of this method, the step of aligning the component pick-up unit with the component may be performed at a higher speed than the step of decreasing the distance between the component pick-up unit and the component.

In this way it is possible to press the element against the object as soon as or after the occurrence of a collision has been established. As a result, the element can be pressed against the object without causing damage to the element or to the object. Moreover, such a method ensures that the element is positioned on the object at a desired position and/or is connected to the object at the desired position, for example by means of a glued joint, vacuum, etc.

The method is particularly suitable for use with a relatively stiff drive system that cannot be compressed against spring force, or that can only be compressed to a limited extent.

The method according to the invention makes it possible to move the component pick-up unit to the component at a relatively high velocity. After the occurrence of a collision has been established, the component pick-up unit can be pressed against the component to be picked-up, so that a reliable temporary connection between the component pick-up unit and the component is established, for example by means of a vacuum. Upon placement of the component on the substrate, the component may be moved to a desired position on the substrate by means of the component pick-up unit. After the occurrence of a collision between the component and the substrate has been established, the component may be pressed against the substrate with a predetermined force, for example for effecting a connection between the component and the substrate. Once the component is pressed against the substrate, the detachable connection between the component pick-up unit and the component may be broken, for example by releasing the vacuum, after which the component pick-up unit may be moved away from the component.

In this way components can be picked-up with a relatively high degree of accuracy and with a controlled force and subsequently can be placed on a substrate.

Another object of the invention is to provide a device that is suitable for carrying out such a method, in which, after the occurrence of a collision between the element and the object has been established, other advantageous measures can be taken.

An embodiment of a device of this nature includes, among other possible things: (a) an element that is configured to be moved by means of a drive system; (b) a processor that is provided with means for determining whether a difference exists between a desired value with an actually measured value; (c) means for establishing that a collision between the element and an object has occurred if the difference as determined is greater than a predetermined parameter; and (d) means for pressing the element against the object in a controlled manner by means of the drive system for a predetermined period of time after the occurrence of a collision has been established.

In another embodiment of the device, the means for determining whether a difference exists between a desired value with an actually measured value may include a position controller.

In another embodiment of the device, the means for pressing the element against the object may include a force controller.

In another embodiment of the device, the element may include a component pick-up unit. The component pick-up unit may include a nozzle that is configured to generate a vacuum for picking-up a component. The object may be a substrate on which the component is configured to be positioned.

In another embodiment of the device, it is possible to press the element against the object in a controlled manner once the occurrence of the collision has been established.

In another embodiment of the device, the means for comparing a desired value with an actually measured value may include a position controller.

In another embodiment of the device, the position controller may make it possible to establish, in a relatively simple manner, that a difference is arising between the expected value and the actually measured value, which is an indication that the element cannot be moved any further because it has collided with the object.

In another embodiment of the device, the means for pressing the element against the object may include a force controller. A force controller may make it possible to press the element against the object with a desired force. It is possible, for example, to supply information about the power consumption required for generating the driving force of the drive system to the force controller. In this way no additional component needs to be used for the force controller. Rather, components that are already available in the system can be used.

These and other features, aspects, and advantages of the present invention will become more apparent from the following description, appended claims, and accompanying exemplary embodiments shown in the drawings.

### BRIEF DESCRIPTION OF THE DRAWINGS

The accompanying drawings, which are incorporated in and constitute a part of the specification, illustrate an embodiment of the invention and together with the description, serve to explain the principles of the invention.

FIG. 1 is a perspective view of a component placing device;

FIG. 2 shows a position controller of the component placing device shown in FIG. 1;

FIG. 3 shows a force controller of the component placing device shown in FIG. 1.

### DETAILED DESCRIPTION OF THE PREFERRED EMBODIMENTS

Reference will now be made in detail to presently preferred embodiments of the invention, which are illustrated in the drawings. An effort has been made to use the same reference numbers throughout the drawings to refer to the same or like parts.

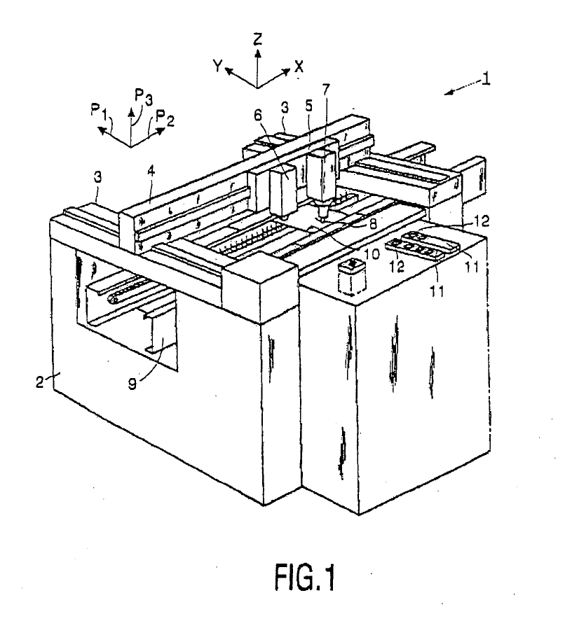

FIG. 1 shows a component placing device 1 comprising a frame 2. The frame 2 supports two parallel rails 3. The rails 3 support a guide 4 that extends transversely to the rails 3. The guide 4 can be moved over the rails 3 in the direction indicated by the arrow P1 and in the opposite direction by means of a drive system. The guide 4 supports an arm 5, which is movable over the guide 4 in the direction indicated by the arrow P2 and in the opposite direction by means of a drive system. The arm 5 supports an image recording device 6 and a component pick-up unit 7. The component pick-up unit 7 comprises a nozzle 8 in which a vacuum can be generated by vacuum means for picking-up a component.

The frame 2 furthermore supports a conveying device 9, which extends parallel to the guide 4 and which is positioned under the guide 4. Substrates 10 can be moved in the direction indicated by the arrow P2 by means of the conveying device 9. The component placing machine 1 is further provided with a component supplying device 11, from which components 12 can be picked-up by means of the component pick-up unit 7. The components 12 that have been picked-up by means of a component pick-up unit 7 are subsequently positioned at a desired position on the substrate 10. It is possible to verify by means of the image recording device 6 whether the component pick-up unit 7 is indeed positioned above the desired position on the substrate 10.

The component placing device 1 according to the invention further comprises a processor for controlling the drive systems of the guide 4 as well as the arm 5 in, respectively, the direction indicated by the arrow PI (i.e., parallel to the Y-direction) and the direction indicated by the arrow P2 (i.e., parallel to the X-direction). The component placing device 1 is further provided with a drive system for moving the nozzle 8 with respect to the component pick-up unit 7 in the direction indicated by the arrow P3 and in the opposite direction, i.e., parallel to the Z-direction. The drive means comprise a servo motor that is provided with means from which the position of the motor can be determined.

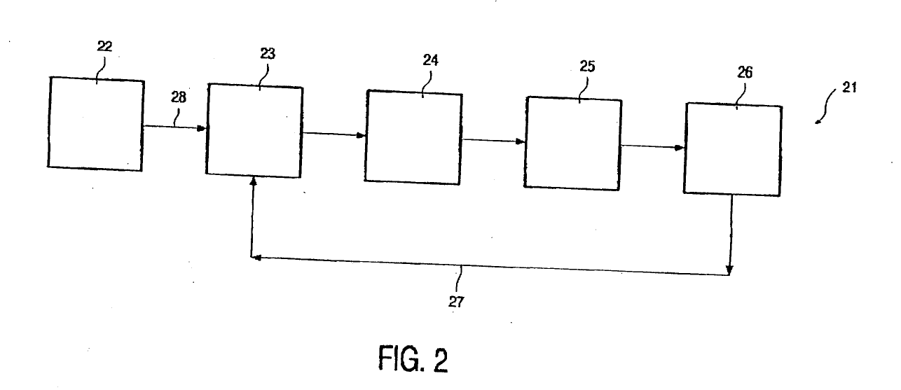

FIG. 2 shows a control diagram 21 of a processor of the component placing device 1 for controlling the movement of the nozzle 8 in the Z-direction and in the opposite direction. The control diagram 21 comprises an adjusting point generator 22, into which the desired position in the Z-direction is input. This position depends on the level at which a component 12 is expected to be present at the component supplying device 11 and, near the substrate 10, on the expected location for positioning the component.

The positions in the Z-direction may vary due to measuring inaccuracies, thickness tolerances, thermal expansions, curvatures of the substrate 10, etc. The information supplied from the generator 22 is fed to a position controller 23, which controls an amplifier 24 of the servo motor 25. A driving current for the motor 25 is generated by means of the amplifier 24, which driving current is directly proportional to the force required for the desired movement. The motor 25 is provided with a position sensor 26 by means of which the actual position of the motor (and, therefore, the actual position 27 of the nozzle 8) may be established. The actually measured position 27 of the nozzle 8 is compared in the position controller 23 with the desired value corresponding to a desired position 28 obtained from the generator 22, after which a desired driving current is determined by means of the amplifier 24.

As soon as a difference between the expected desired value and the actually measured value in the position controller 23 exceeds a predetermined, allowable value, a relatively large driving current will be generated by means of the amplifier 24. The processor will consider such a relatively large driving current to be indicative of the occurrence of a collision between the nozzle 8 and the component 12 that is to be picked-up, for example, or of a collision between the component 12 that has been picked-up by means of the nozzle 8 and the substrate 10. The relatively large driving current will cause the nozzle 8 to be pressed against the object in question with a specific force.

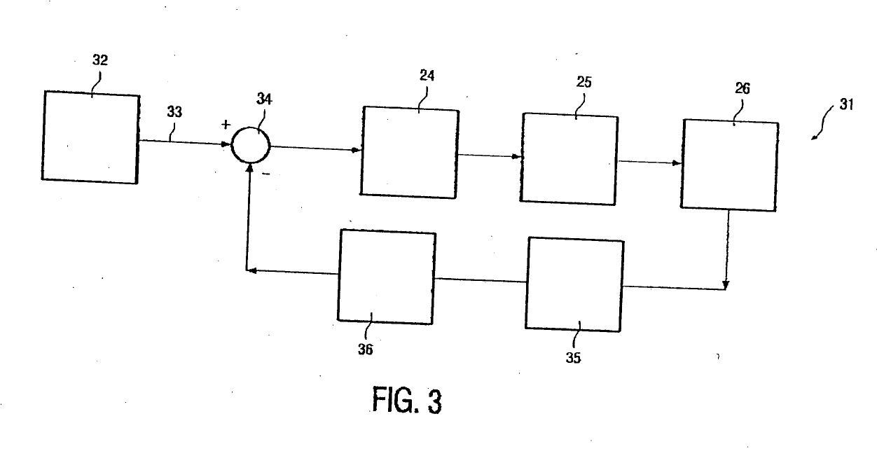

Subsequently, a switch is made by means of the processor to a control diagram 31 (shown in FIG. 3), by means of which: (a) the nozzle 8 is pressed against a component 12 upon picking-up the component 12; or (b) the nozzle 8 and a component 12 are jointly pressed against a substrate 10 upon placement of the nozzle 8/component 12 on the substrate 10, with a predetermined force as adjusted in a force adjusting unit 32; the force is directly proportional to the driving current required for the motor 25. The desired force value 33 is fed to a comparator 34, from which a signal is passed to the amplifier 24 of the motor 25. In the position sensor 26 of the motor 25, the position of the motor 25 (and, therefore, the nozzle 8) is determined in a similar manner as in the control diagram 21. The information from the position sensor 26 is fed to a differentiator 35, by means of which the velocity of movement of the nozzle 8 is determined. Once the occurrence of a collision has been established, the shaft of the motor 25 may be stopped so that the desired speed of the motor equals zero.

If the differentiator 35 detects a value deviating from zero, the value is amplified with an amplifier 36 and the value thus obtained is fed to the comparator 34 for reducing the driving current generated by means of the amplifier and, therefore, reducing the force exerted by means of the motor 25.

The force is used for pressing the nozzle against the object in question for a predetermined period of time. In this way, the nozzle 8 is pressed against the component 12 to be picked-up or against the substrate 10 with a desired force for a predetermined period of time. When a component 12 is picked-up by means of the nozzle 8, the vacuum is turned on as soon as or just after the occurrence of a collision has been established, so that the component 12 is sucked against the nozzle 8. Upon placement of the component 12 on the substrate 10, the vacuum in the nozzle 8 is released in a similar manner after the occurrence of the collision has been established, so that the nozzle 8 can be moved away from the substrate 10, with the component 12 remaining behind at the desired position on the substrate 10.

As long as the nozzle 8 is present at a relatively large distance from a component 12 to be picked-up or from the desired position on the substrate 10, the nozzle 8 can be moved at a relatively high velocity, which may be a constant velocity. As soon as the nozzle 8 is relatively close to the component 12 to be picked-up or to the desired position on the substrate 10, the velocity of movement of the nozzle 8 is reduced, so that the force of the collision between the nozzle 8 and the component 12 to be picked-up or the substrate 10 is relatively limited, preferably equal to the force with which the nozzle 8 is to be pressed against the component 12 to be picked-up or the substrate 10.

Although the aforementioned describes embodiments of the invention, the invention is not so restricted. It will be apparent to those skilled in the art that various modifications and variations can be made to the disclosed preferred embodiments of the present invention without departing from the scope or spirit of the invention. For example, it is also possible to provide the nozzle with other means for picking-up a component, such as a gripper, an electromagnet, etc. Accordingly, it should be understood that the apparatus and method described herein are illustrative only and are not limiting upon the scope of the invention, which is indicated by the following claims.

1. A method for moving an element by means of a drive system , the method comprising the steps of:
determining a difference between a predetermined value of the position of the element and an actually measured value at frequent intervals by means of a processor during the movement of the element;
establishing that a collision of the element with an object has taken place if the difference is greater than a predetermined parameter; and
pressing the element against the object, by means of the drive system, in a controlled manner and for a predetermined period of time, when the occurrence of a collision has been established.

2. The method according to claim 1, wherein a force with which the element is pressed against the object is maintained at a predetermined value by means of the processor.

3. The method according to claim 1, wherein the element is initially moved relative to the object at a relatively high velocity, and wherein as the element nears the object, the speed at which the element is moved relative to the object is reduced.

4. The method according to claim 1, wherein the element comprises a component pick-up unit that is provided with a nozzle that generates a vacuum for picking-up a component.

5. The method according to claim 4, wherein the object comprises a component to be picked-up, and wherein the method further comprises the steps of:
turning on the vacuum; and
picking-up the component with the nozzle as soon as or after the occurrence of a collision between the nozzle and the component has been established.

6. The method according to claim 4, wherein the object comprises a substrate on which a component is to be positioned, wherein the element further comprises a component picked-up by means of the nozzle's vacuum, and wherein the method further comprises the step of:
releasing the vacuum as soon as or just after the occurrence of a collision between the component and the substrate has been established.

7. The method according to claim 6, wherein the method further comprises the step of:
moving the component pick-up unit and the nozzle away from the substrate after the end of the predetermined period of time during which the component is pressed against the substrate.

8. The method according to claim 2, wherein the method further comprises the step of:
adjusting the predetermined value of the force with which the element is pressed against the object.

9. A device comprising:
an element that is configured to be moved by means of a drive system;
a processor that is provided with means for determining whether a difference exists between a desired value with an actually measured value;
means for establishing that a collision between the element and an object has occurred if the difference as determined is greater than a predetermined parameter; and
means for pressing the element against the object in a controlled manner by means of the drive system for a predetermined period of time after the occurrence of a collision has been established.

10. The device according to claim 9, wherein the means for determining whether a difference exists between a desired value with an actually measured value comprise a position controller.

11. The device according to claim 9, wherein the means for pressing the element against the object comprise a force controller.

12. The device according to claim 9, wherein the element comprises a component pick-up unit having a nozzle that is configured to generate a vacuum for picking-up a component, and wherein the object is a substrate on which the component is configured to be positioned.

13. A method of moving a component, the method comprising the steps of:
aligning a component pick-up unit with the component;
decreasing the distance between the component pick-up unit and the component;
determining when a collision has occurred between the component pick-up unit and the component;
attaching the component to the component pick-up unit;
moving the component and the component pick-up unit so as to align the component with a particular region of a substrate;
decreasing the distance between the component and the particular region of the substrate;
determining when a collision has occurred between the component and the particular region of the substrate; and
releasing the component onto the particular region of the substrate.

14. The method according to claim 13, wherein the component pick-up unit comprises a nozzle that is configured to create a vacuum, and wherein the step of attaching the component to the component pick-up unit comprises:
establishing a vacuum between the component and an end of the nozzle.

15. The method according to claim 14, wherein the step of depositing component on the particular region of the substrate comprises:
releasing the vacuum between the component and an end of the nozzle.

16. The method according to claim 15, wherein the step of determining when the collision has occurred between the component pick-up unit and the component comprises:
comparing an expected location of the nozzle to an actual location of the nozzle.

17. The method according to claim 13, wherein the step of determining when the collision has occurred between the component pick-up unit and the component comprises:
comparing an expected location of the component pick-up unit to an actual location of the component pick-up unit.

18. The method according to claim 14, wherein the step of determining when the collision has occurred between the component pick-up unit and the component comprises:
comparing an expected location of the nozzle to an actual location of the nozzle.

19. The method according to claim 13, wherein the step of aligning the component pick-up unit with the component is performed at a higher speed than the step of decreasing the distance between the component pick-up unit and the component.

20. The method according to claim 19, wherein the step of determining when the collision has occurred between the component pick-up unit and the component comprises:
comparing an expected location of the nozzle to an actual location of the nozzle.
